(19) United States
(12) Patent Application Publication
(10) Pub. No.: US 2006/0250645 A1
(43) Pub. Date: Nov. 9, 2006

(54) Controlling display based on job status information

(76) Inventor: Ryonosuke Miyazaki, Tokyo-to (JP)

Correspondence Address: HARNESS, DICKEY & PIERCE, P.L.C., P.O. BOX 8910, RESTON, VA, 20195, US

(21) Appl. No.: 11/412,799

(22) Filed: Apr. 28, 2006

(30) Foreign Application Priority Data
Apr. 28, 2005 (JP) 2005-132263

(51) Int. Cl. G06F 3/12

(52) U.S. Cl. 358/1.15

(57) ABSTRACT

An apparatus, method, system, computer program and product, each capable of controlling display based on job status information.

### CROSS-REFERENCE TO RELATED APPLICATIONS

This patent application is related to and claims priority under 35 U.S.C. §119 to Japanese patent application No. 2005-132263 filed on Apr. 28, 2005, in the Japanese Patent Office, the entire contents of which are hereby incorporated by reference.

### FIELD OF THE INVENTION

The following disclosure relates generally to an apparatus, method, system, computer program and product, each capable of controlling display based on job status information.

### DESCRIPTION OF THE RELATED ART

The existing image forming apparatus is provided with the function of performing a plurality of jobs concurrently or sequentially. For example, the existing image forming apparatus may be provided with the function of registering, which allows a user to register a new job while performing a current job. Once the registering function is selected, the existing image forming apparatus causes its display to switch from a first screen showing the status of the current job to a second screen showing the status of the new job. Using the second screen, the user can input information regarding the new job without waiting for the current job to be completed. Once the current job is completed, the existing image forming apparatus performs the new job according to the information input by the user.

However, the existing image processing apparatus keeps displaying the second screen even when the second screen is not in use. This may be inconvenient to the user as the user can hardly obtain information regarding the current job, especially when the current job is interrupted or cancelled due to an error.

### SUMMARY

In light of the above-described and other problems, in one example embodiment, the present invention provides an apparatus, method, system, computer program and product, each capable of controlling display according to job status information.

For example, an image forming apparatus may be provided, which is capable of performing a plurality of jobs while controlling its display according to job status information of the plurality of jobs. In an example operation, the display displays a first screen showing information regarding a first job. Once a command for registering a second job is input, the display switches from the first screen, to a second screen showing information regarding the second job. At a timing when or after the image forming apparatus completes a reading operation on the second job, the display switches from the second screen back to the first screen.

### BRIEF DESCRIPTION OF THE DRAWINGS

A more complete appreciation of the disclosure and many of the attendant advantages thereof will be readily obtained as the same becomes better understood by reference to the following detailed description when considered in connection with the accompanying drawings, wherein:

FIG. 1 is a schematic block diagram illustrating the functional structure of an image forming apparatus according to an example embodiment of the present invention;

FIG. 2 is a perspective view illustrating the outer appearance of an image forming apparatus according to an example embodiment of the present invention;

FIG. 3 is a schematic block diagram illustrating a portion of the hardware structure of the image forming apparatus shown in FIG. 2 according to an example embodiment of the present invention;

FIG. 4 is a cross sectional view illustrating the structure of a scanner and a printer of the image forming apparatus shown in FIG. 3 according to an example embodiment of the present invention;

FIG. 5 is a schematic block diagram illustrating the structure of a storage device of the image forming apparatus shown in FIG. 3 according to an example embodiment of the present invention;

FIG. 6 is a front view illustrating the appearance of an operation panel of the image forming apparatus shown in FIG. 3 according to an example embodiment of the present invention;

FIG. 7 is a front view illustrating a first job screen displayed by a display of the operation panel shown in FIG. 6 according to an example embodiment of the present invention;

FIG. 8A is a front view illustrating a second job screen displayed by the display of the operation panel shown in FIG. 6 according to an example embodiment of the present invention;

FIG. 8B is a front view illustrating a second job screen displayed by the display of the operation panel shown in FIG. 6 according to an example embodiment of the present invention;

FIG. 9 is a flowchart illustrating the operation of controlling the display of the image forming apparatus shown in FIG. 3 according to an example embodiment of the present invention;

FIG. 10A is a job management table stored in the storage device of the image forming apparatus shown in FIG. 3 according to an example embodiment of the present invention;

FIG. 10B is a job management table stored in the storage device of the image forming apparatus shown in FIG. 3 according to an example embodiment of the present invention;

FIG. 10C is a job management table stored in the storage device of the image forming apparatus shown in FIG. 3 according to an example embodiment of the present invention;

FIG. 11 is a front view illustrating a second job screen displayed by the display of the operation panel shown in FIG. 6 according to an example embodiment of the present invention;

FIG. 12 is a front view illustrating a settings screen displayed by the display of the operation panel shown in FIG. 6 according to an example embodiment of the present invention;

FIG. 13 is a flowchart illustrating the operation of controlling the display of the image forming apparatus shown in FIG. 3 according to an example embodiment of the present invention;

FIG. 14 is a front view illustrating a third job screen displayed by the display of the operation panel shown in FIG. 6 according to an example embodiment of the present invention;

FIG. 15 is a job management table stored in the storage device of the image forming apparatus shown in FIG. 3 according to an example embodiment of the present invention;

FIG. 16 is a front view illustrating a second job screen displayed by the display of the operation panel shown in FIG. 6 according to an example embodiment of the present invention;

FIG. 17 is a front view illustrating a second job screen displayed by the display of the operation panel shown in FIG. 6 according to an example embodiment of the present invention;

FIG. 18 is a front view illustrating a second job screen displayed by the display of the operation panel shown in FIG. 6 according to an example embodiment of the present invention; and

FIG. 19 is a front view illustrating a second job screen displayed by the display of the operation panel shown in FIG. 6 according to an example embodiment of the present invention.

### DETAILED DESCRIPTION OF THE EXAMPLE EMBODIMENTS

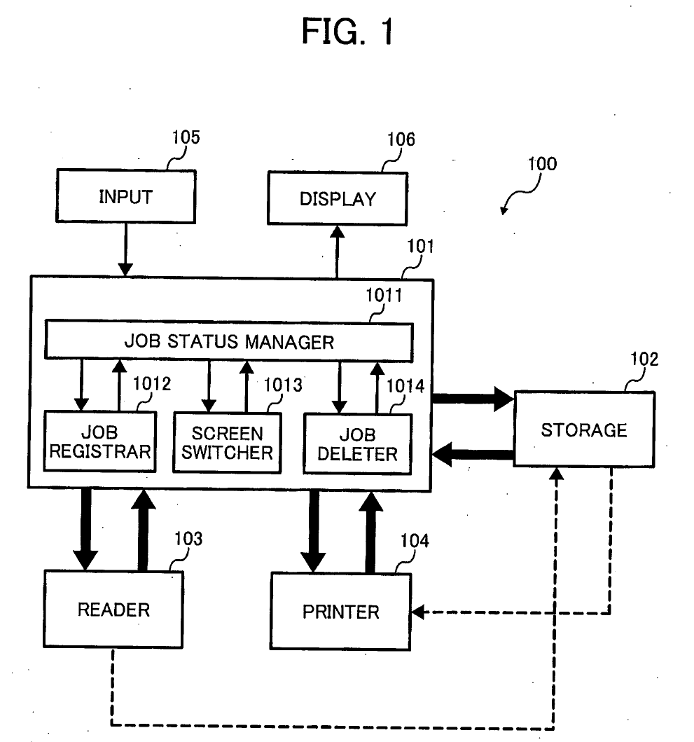

In describing the example embodiments illustrated in the drawings, specific terminology is employed for clarity. However, the disclosure of this parent specification is not intended to be limited to the specific terminology selected and it is to be understood that each specific element includes all technical equivalents that operate in a similar manner. Referring now to the drawings, wherein like reference numerals designate identical or corresponding parts throughout the several views, FIG. 1 illustrates an image forming apparatus 100 according to an example embodiment of the present invention. The image forming apparatus 100 is capable of performing a plurality of jobs concurrently or sequentially.

Referring to FIG. 1, the image forming apparatus 100 includes a controller 101 including a job status manager 1011, a job registrar 1012, a screen switcher 1013, and a job deleter 1014, a storage 102, a reader 103, a printer 104, an input 105, and a display 106.

The reader 103 reads an original document into image data. The storage 102 stores the image data read by the reader 103. The printer 104 prints the image data stored by the storage 102 as a printed document. The input 105 inputs various data, such as a job execution command that causes the reader 103, the storage 102, and the printer 104 to sequentially or concurrently perform the operations of reading, storing, and printing in one job. The display 106 displays various kinds of screen, such as a screen showing information regarding the job.

The controller 101 monitors or controls at least one of the operations performed by the input 105, the display 106, the storage 102, the reader 103, and the printer 104 to complete the job. The job registrar 1012 registers the job in response to the job execution command. The job status manager 1011 manages job status information of the job according to at least one of the operations performed by the input 105, the reader 103, the printer 104, and the storage 102. The job deleter 1014 deletes the job registered by the job registrar 1012, according to the job status information managed by the job status manager 1011. The screen switcher 1013 switches the screen of the display 106.

In an example operation, the image forming apparatus 100 sequentially or concurrently performs a first job and a second job, while controlling the screen of the display 106 according to relative relationship of first job status information of the first job and second job status information of the second job. As described below, the image forming apparatus 100 causes the display 106 to display a first screen showing information regarding the first job or a second screen showing information regarding the second job, while performing the first job and the second job. The screen switcher 1013 causes the display 106 to switch between the first screen and the second screen at a timing determined by the relative relationship between the first job status information and the second job status information.

For example, the display 106 displays a waiting-mode screen, which allows the input 105 to input a first job execution command. In this example, the first job execution command causes the reader 103, the storage 102, and the printer 104 to sequentially or concurrently perform the operations of reading, storing, and printing in the first job. Once the first job execution command is input, the job registrar 1012 registers the first job by storing various information regarding the first job, such as first job settings information that indicates the current settings of the first job, or first job status information that indicates a current operation performed on the first job. In this example, the first job status information is initially set to a first status corresponding to the operation of inputting. Further, in response to the first job execution command, the screen switcher 1013 may cause the display 106 to display a first screen including information regarding the first job. Using this first screen, the input 105 may set the first job settings information.

Once the first job settings information is set, the controller 101 causes the reader 103 and the storage 102 to start the reading operation and the storing operation on the first job. At this time, the job status manager 1011 changes the first job status information from the first status, to a second status corresponding to the operations of reading and storing.

Further, when there is no job currently running or waiting before the first job, the controller 101 may cause the printer 104 to perform the printing operation on the first job, simultaneously with the reading or storing operation. At this time, the job status manager 1011 changes the first job status information from the second status, to a third status corresponding to the operations of reading, storing, and printing.

When the reading and storing operations are completed for the first job, the job status manager 1011 charges the first job status information from the second status or third status, to a fourth status corresponding to the operation of printing. At the same time, the screen switcher 1013 causes the display 106 to additionally display a register key on the first screen, which allows the input 105 to input a second job execution command. In this example, the second job execution command causes the reader 103, the storage 102, and the printer 104 to sequentially or concurrently perform the operations of reading, storing, and printing in the second job. Once the second job execution command is input, the job registrar 1012 registers the second job by storing various information regarding the second job, such as second job settings information that indicates the current settings of the second job, or second job status information that indicates a current operation performed on the second job. In this example, the second job status information is initially set to the first status corresponding to the operation of inputting. At the same time, the screen switcher 1013 causes the display 106 to switch, from the first screen, to a second screen, which allows the input 105 to set the second job settings information.

Once the second job settings information is set, the controller 101 causes the reader 103 and the storage 102 to start the reading operation and the storing operation on the second job. At this time, the job status manager 1011 chances the second job status information from the first status, to the second status corresponding to the operations of reading and storing. Since the printer 104 is currently performing the printing operation on the first job, the printer 104 is not allowed to perform the printing operation on the second job.

When the reading and storing operations are completed for the second job, the job status manager 1011 changes the second job status information, from the second status, to a fifth status corresponding to an operation of waiting, which indicates the status in which none of the operations of inputting, reading, storing, and printing is being performed. When or after the second job status information is changed to the fifth status, the screen switcher 1013 causes the display 106 to switch from the second screen back to the first screen.

When the printing operation on the first job is completed, the job deleter 1014 deletes the first job by removing various information regarding the first job. The job status manager 1011 then changes the second job status information from the fifth status to the fourth status corresponding to the operation of printing. At this time, the printer 104 starts the printing operation on the second job. At the same time, the screen switcher 1013 displays the second screen showing information regarding the second job.

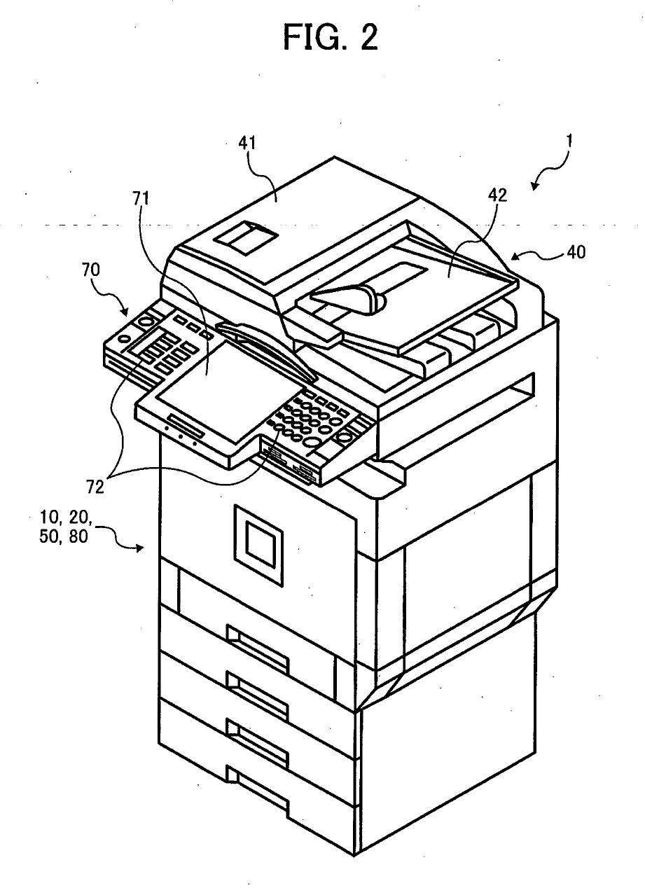

The image forming apparatus 100 may be implemented in various ways, for example, as an image forming apparatus 1 shown in FIG. 2. The examples of the job performed by the image forming apparatus 1 include, but not limited to, scanning an original document into image data, reading image data from a removable mediums storing image data, printing image data, and copying an original document. As described above referring to FIG. 1, the image forming apparatus 1 is capable of performing more than one job concurrently or sequentially.

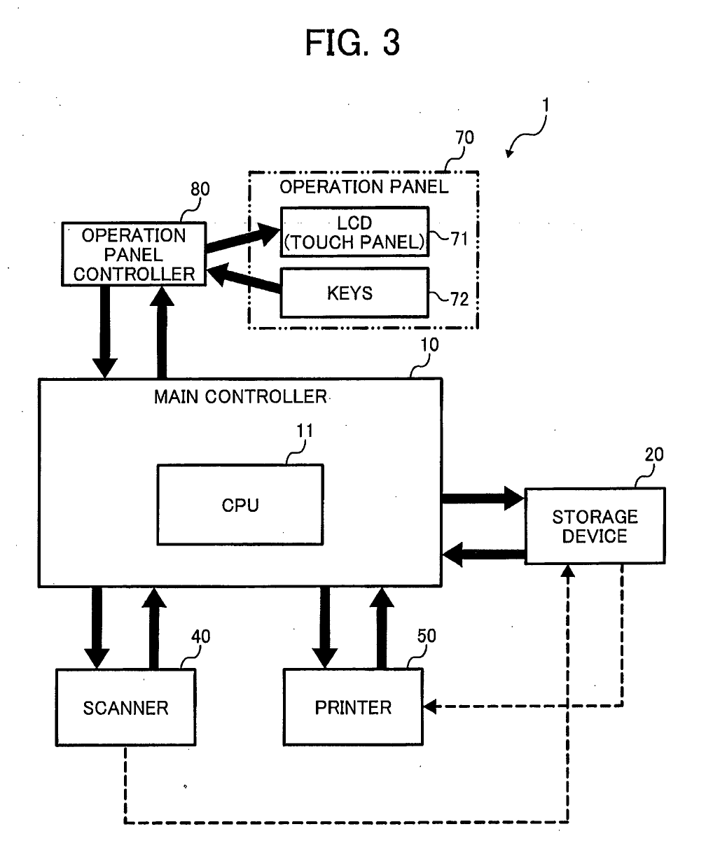

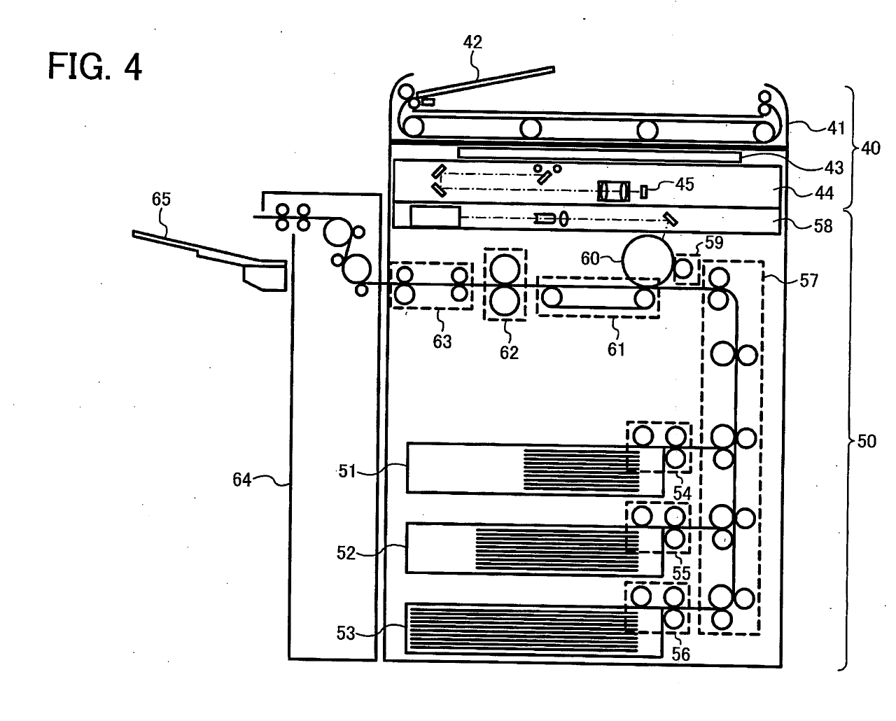

Referring to FIGS. 2 and 3, the image forming apparatus 1 mainly includes a main controller 10, a storage device 20, a scanner 40, a printer 50, an operation panel 70, and an operation panel controller 30. As shown in FIG. 2, the scanner 40, having an automatic document feeder (ADF) 41 and a document tray 42, is mounted on the top surface of the image forming apparatus 1. The operation panel 70, having a liquid crystal display (LCD) 71 and a group of keys (keys) 72, is provided at one side surface of the image forming apparatus 1. The image forming apparatus 1 may be provided with any other element or device, such as a finisher 64 or an output tray 65 shown in FIG. 4.

Referring to FIG. 3, the main controller 10 includes a central processing unit (CPU) 11, which controls operation of the image forming apparatus 1. The scanner 40 scans an original document into image data. The storage device 20 stores various data including the image data scanned by the scanner 40. The printer 50 prints the image data as a printed document. The operation panel controller 80 controls communication between the main controller 10 and the operation panel 70. The operation panel 70 allows a user to input various data via the keys 72, while displaying various data received from the main controller 10 on the LCD 71.

Referring now to FIG. 4, the structure and the operation of the scanner 40 is explained according to an example embodiment of the present invention. The scanner 40 mainly includes the ADF 41, the document tray 42, an exposure glass 43, and an image reading device 44 including an image sensor 45. In an example operation, an original document may be placed on the document tray 42 or on the exposure glass 43. If the original document is placed on the document tray 42, the ADF 41 feeds the original document onto the exposure glass 43. The original document, placed on the exposure glass 43, is read into image data by the image reading device 44 having the image sensor 45. The image-sensor 45 may be implemented by a charged coupled device (CCD), for example. The image data is sent to the storage device 20 of FIG. 3 under control of the main controller 10 of FIG. 3.

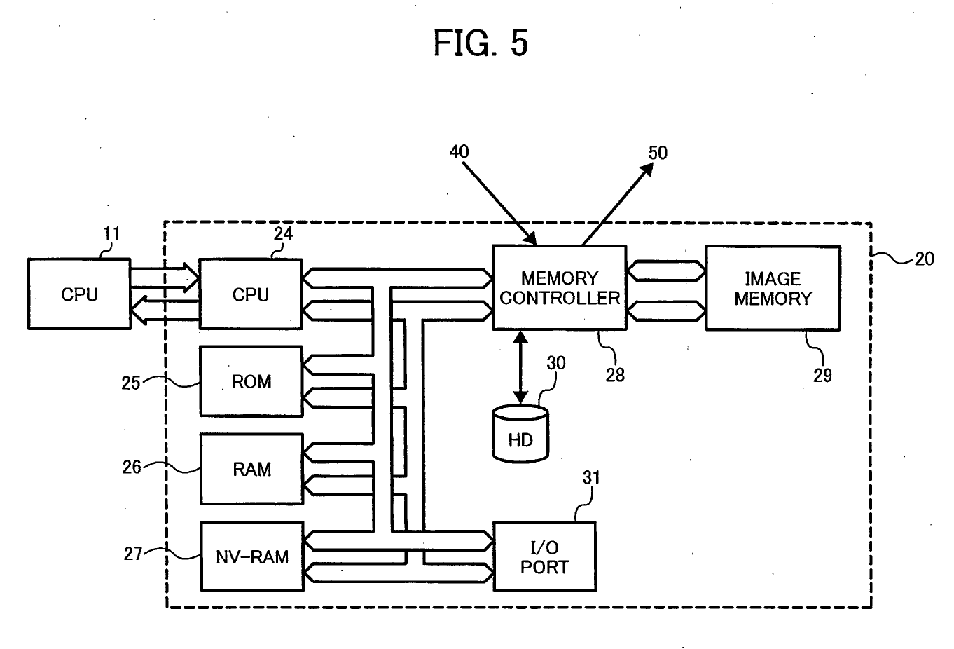

Referring now to FIG. 5, the structure and the operation of the storage device 20 is explained according to an example embodiment of the present invention. The storage device 20 includes a CPU 24, a read only memory (ROM) 25, a random access memory (RAM) 26, a non-volatile RAM (NVRAM) 27, a memory controller 28, an image memory 29, a hard disk drive (HD) 30, and an input/output port 31.

The CPU 24, which is coupled to the CPU 11 of the main controller 10, controls operation of the memory controller 28, using data stored in any one of the ROM 25, the RAM 26, and the NV-RAM 27. For example, upon receiving the image data from the scanner 40, the CPU 24 causes the memory controller 28 to store the image data in either one of the image memory 29 and the HD 30. Further, under control of the main controller 10, the CPU 24 causes the memory controller 26 to send the image data to the printer 50 for further processing. In this example, various image processing may be applied to the image data before storing, such as analog/digital conversion, shading correction, MTF (modulation transfer function) correction, gamma correction, size conversion, compression, etc. Similarly, various image processing may be applied to the image data before sending to the printer 50. Further, in addition to the data stored in any one of the ROM 25, RAM 26, and NV-RAM 27, the CPU 24 may use data obtained from the outside through the I/O port 31, for example.

Referring back to FIG. 4, the structure and the operation of the printer 50 is explained according to an example embodiment of the present invention. The printer 50 includes a first tray 51, a second tray 52, a third tray 53, a first feeder 54, a second feeder 55, a third feeder 56, a transfer device 57, a writing device 58, a developer 59, a photoconductor 60, an intermediate transfer device 61, a fixing device 62, a fourth feeder 63, the finisher 64, and the output tray 65.

In an example operation, the writing device 58 forms a latent image on the surface of the photoconductor 60 according to the image data, which is received from the storage device 20 under control of the main controller 10. The developer 59 develops the latent image into a toner image. The toner image is then transferred to a recording medium, which is carried by the intermediate transfer device 61. In this example, the recording medium is transferred to the intermediate transfer device 61 from any one of the first tray 51, second tray 52, and third tray 52 by the corresponding one of the first feeder 54, second feeder 55, and third feeder 56, through the transfer device 57. The recording medium having the toner image thereon is further transferred to the fixing device 62 by the intermediate transfer device 61. The fixing device 62 then fixes the toner image onto the recording medium. The recording medium is further carried by the fourth feeder 63 through the finisher 64 onto the output tray 65.

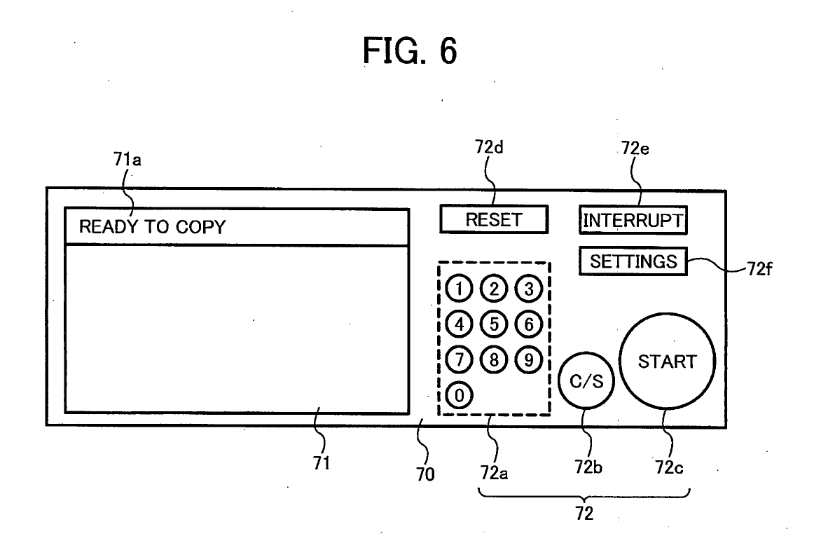

Referring now to FIG. 6, the structure and the operation of the operation panel 70 is explained according to an example embodiment of the present invention. The LCD 71 displays various kinds of screen according to data received from the main controller 10 via the operation panel controller 80. In this example, the LCD 71 is integrated with a touch panel, which allows the user to make the selection according to the contents of the screen displayed by the LCD 71. The selection is sent to the main controller 10 via the operation panel controller 80. Further, as shown in FIG. 6, the LCD 71 includes an indicator section 71a, which indicates the current status of a job performed by the image forming apparatus 1.

Still referring to FIG. 6, in this example, the keys 72 include the ten key 72a, the C/S key 72b, the “START” key 72c, the “RESET” key 72d, the “INTERRUPT” key 72e, and the “SETTINGS” key 72f. When one of the keys 72 is pressed, the operation panel controller 80 notifies the main controller 10 of the key that has been pressed. According to this notification, the main controller 10 controls the operation of the mage forming apparatus 1. In an example operation, the ten key 72a allows the user to input the number of pages to be copied. The C/S key 72b allows the user to cancel or stop a current job performed by the image forming apparatus 1. The “START” key 72e allows the user to start a new job or confirm information that has been selected. The “RESET” key 72d allows the user to clear the previous input and return to the default settings. The “INTERRUPT” key 72e allows the user to interrupt a current job. The “SETTINGS” key 72f allows the user to change the default settings.

As described above referring to FIG. 1, the image forming apparatus 1 is capable of performing a plurality of jobs concurrently or sequentially, while controlling the screen of the LCD 71 according to job status information of the plurality of jobs.

For example, the ROM 25 of the storage device 20 may store a display control program. When activated by the CPU 11, the display control program causes the CPU 11 to function as the controller 101 of FIG. 1. In another example, the display control program may be stored in a memory of the main controller 10. In yet another example, the display control program may be obtained from the outside through the I/O port 31 from a removable medium, or it may be downloaded from a network such as the Internet.

In an example operation, the LCD 71 displays a waiting-mode screen, which allows the user to input a job execution command. As illustrated in FIG. 6, the waiting-mode screen may display the phrase “READY TO COPY” in the indicator section 71a to indicate that no job is being performed by the image forming apparatus 1.

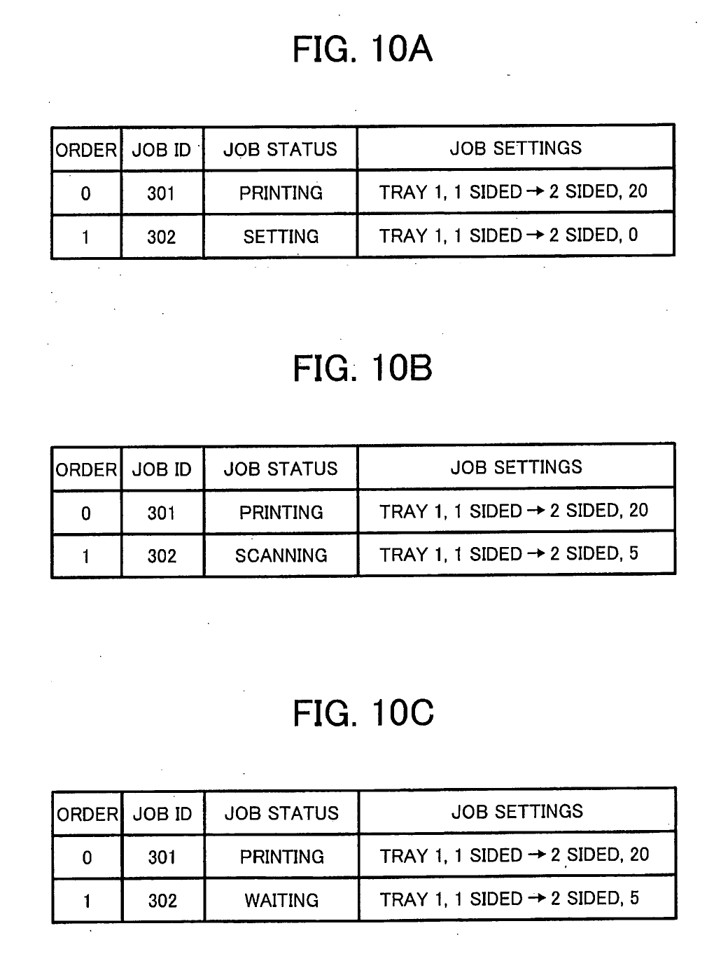

In this example, the user instructs the image forming apparatus 1 to perform a first job, which is to copy a first original document of 20 pages with the default settings. More specifically, the user places the first original document on the document tray 42 (FIG. 4), and presses the “START” key 72c (FIG. 6). Once the “START” key 72c is pressed, the CPU 11 registers the first job by storing various information regarding the first job, such as the first job settings information or the first job status information. In this example, such information is stored in the RAM 26 (FIG. 5) of the storage device 20 as a job management able, which will be described below referring to any one of FIGS. 10A to 10C. Once the first job is registered, the image forming apparatus 1 starts the operations of scanning the first original document into image data using the scanner 40, storing the image data in the image memory 29 (FIG. 5) of the storage device 20, and printing the image data using the printer 50. At this time, the LCD 71 (FIG. 6) displays a screen showing information regarding the first job.

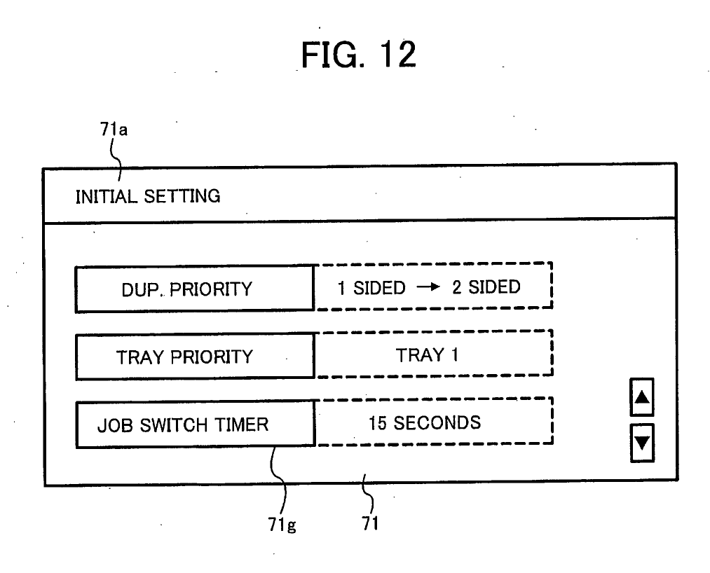

In this example, as illustrated in any one of FIGS. 10A to 10C, the job management table stores the order number, job ID, job status information, and job settings information in a corresponding manner for each one of a plurality of jobs that has been registered by the user. The order number indicates the order in which the corresponding job is performed. The job ID corresponds to an arbitrary number uniquely assigned to the corresponding job at the time of registration. The job status information indicates the current status of the corresponding job. The job settings information indicates the current settings of the corresponding job, such as the selection of tray, the selection of double-sided copy, the number of pages to be copied, etc. Some of the job settings information may be set by default before registering any job, for example, using a settings screen shown in FIG. 12. Such default settings may be changed any time by the user.

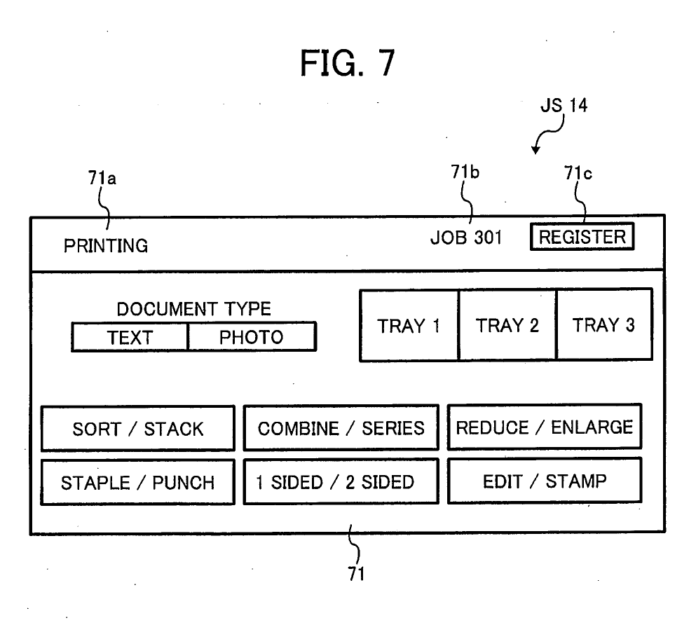

Once all 20 pages of the first original document are scanned, the CPU 11 causes the LCD 71 to display a first job screen JS14 including a “REGISTER” key 71c as illustrated in FIG. 7, to allow the user to register a new job. In addition to the “REGISTER” key 71c, the first job screen JS14 of FIG. 7 displays the first job status information indicating the current status of the first job in the indicator section 71a, and a job ID “301” uniquely assigned to the first job in a job ID section 71b.

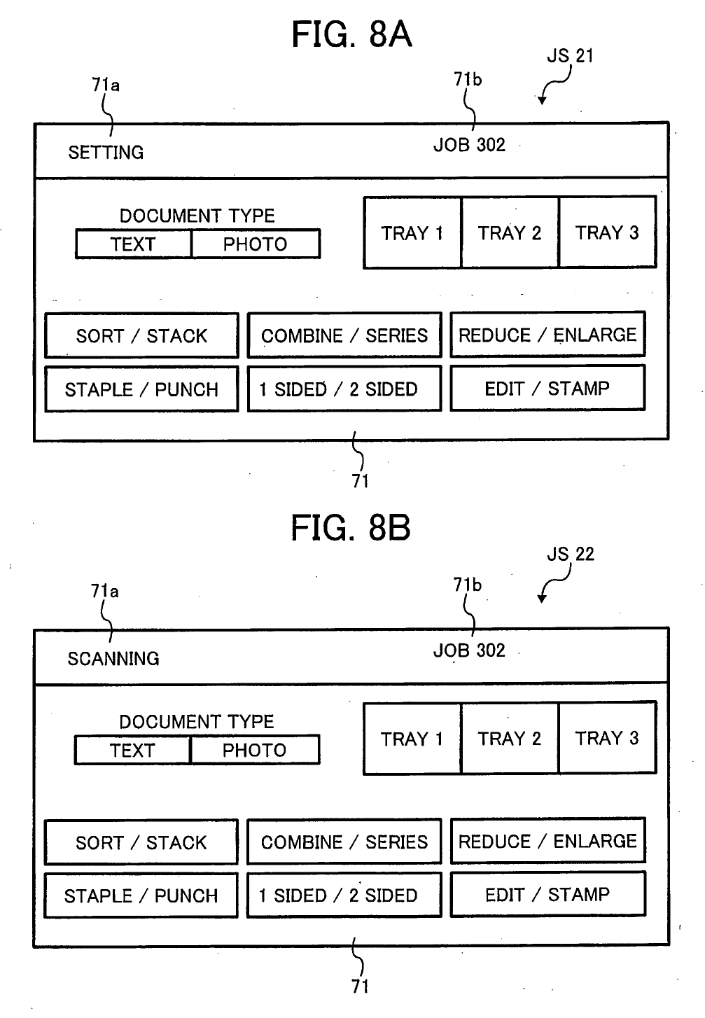

In this example, the user instructs the image forming apparatus 1 to perform a second job, which is to copy a second original document of 5 pages with the default settings, by pressing the “REGISTER” key 71c of the first job screen JS14. Once the “REGISTER” key 71c is pressed, the CPU 11 registers the second job by adding various information regarding the second job, such as the second job settings information or the second job status information, to the job management table stored in the RAM 26 (FIG. 5) of the storage device 20. At the same time, the CPU 11 causes the LCD 71 to switch from the first job screen JS14 shown in FIG. 7, to a screen showing information regarding the second job such as a second job screen JS21 illustrated in FIG. 8A. The second job screen JS21 of FIG. 8A displays the second job status information indicating the current status of the second job in the indicator section 71a, and a job ID “302” uniquely assigned to the second job in the job ID section 71b. The user then places the second original document of 5 pages on the document tray 42 (FIG. 4).

The image forming apparatus 1 scans the second original document into image data using the scanner 40, and stores the image data in the image memory 29 (FIG. 5) of the storage device 20. At this time, the CPU 11 notifies the user that the second job status information has been updated, by switching the screen of the LCD 71 from the second job screen JS21 of FIG. 8A to a second job screen JS22 of FIG. 8B. When all 5 pages of the second original document are scanned, the CPU 11 causes the LCD 71 to switch from the second job screen JS22 of FIG. 8B tack to the first job screen J314 of FIG. 7. In this manner, the user can be automatically informed of the first job, which is currently performed by the image forming apparatus 1, even after registering the second job.

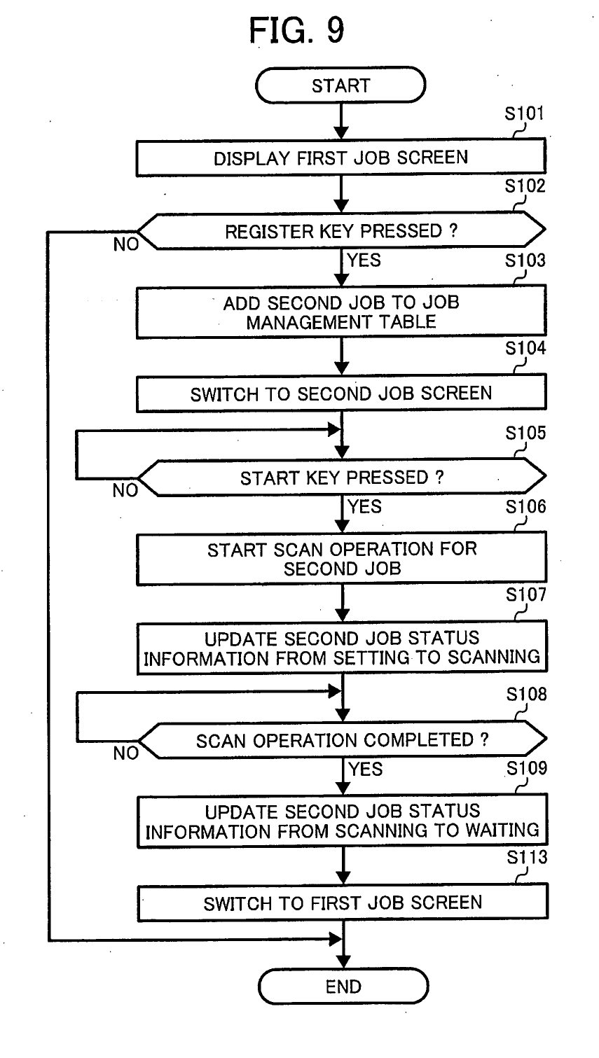

Referring now to FIG. 9, the operation of controlling the screen of the LCD 71 is explained in more detail according to ar example embodiment of the present invention. The operation shown in FIG. 9 is performed by the CPU 11, when the first job is being performed as described above.

Step S101 displays the first job screen JS14 showing information regarding the first job as illustrated in FIG. 7. The first job screen JS14 of FIG. 7 is provided with the “REGISTER” key 71c.

Step 102 determines whether the “REGISTER” key 71c has been pressed by the user. If it is determined that the “REGISTER” key 71c has been pressed (“YES” in Step S102), the operation proceeds to Step S103. Otherwise (“NO” in Step S102), the operation ends to continuously monitor any command from the user while performing the first job.

Step S103 adds information regarding the second job to the job management table stored in the RAM 26 (FIG. 5). In this example, as illustrated in FIG. 10A, the job management table stores information regarding the first job, including the order number of 0, the job ID of “301”, the first job status information that has been set to “PRINTING”, and the first job settings information having the default settings. Once the “REGISTER” key 71c is pressed, the CPU 11 adds information regarding the second job, such as the order number of 1, the job ID of “302”, the second job status information that has been set to “SETTING”, and the second job settings information having the default settings.

Step S104 causes the LCD 71 to switch from the first job screen JS14 of FIG. 7 to the second job screen JS21 of FIG. 8A. The second job screen JS21 of FIG. 8A indicates that the second job status information is set to “SETTING”. At this time, the user places the second original document on the document tray 42 (FIG. 4). Further, the user may change the second job settings information using the touch panel or the keys 72.

Step S105 determines whether the “START” key 72c (FIG. 6) has been pressed by the user. If it is determined that the “START” 72c key has been pressed (“YES” in Step S105), the operation proceeds to Step S106. Otherwise (“NO” in Step S106), the operation repeats Step S105.

Step S106 starts the operation of scanning the second original document into image data, using the scanner 40 (FIG. 3).

Step S107 updates the job management table by changing the second job status information from “SETTING” to “SCANNING”, for example, as illustrated in FIG. 10B. Accordingly, the LCD 71 is switched from the second job screen JS21 of FIG. 8A to the second job screen JS22 of FIG. 8B. The second job screen JS22 of FIG. 8B indicates that the second job status information is set to “SCANNING”. Further, the second job settings information additionally includes the number of pages to be copied, which is “5”.

Step S108 determines whether the scanning operation, which is started in Step S106, is completed. If the scanning operation is completed (“YES” in Step S108), the operation proceeds to Step S109. Otherwise (“NO” in Step S108), the operation repeats Step S108.

Step S109 updates the job management table by changing the second job status information from “SCANNING” to “WAITING”, for example, as illustrated in FIG. 10C.

Step S113 causes the LCD 71 to switch from the second job screen JS22 of FIG. 8B back to the first job screen JS14 of FIG. 7.

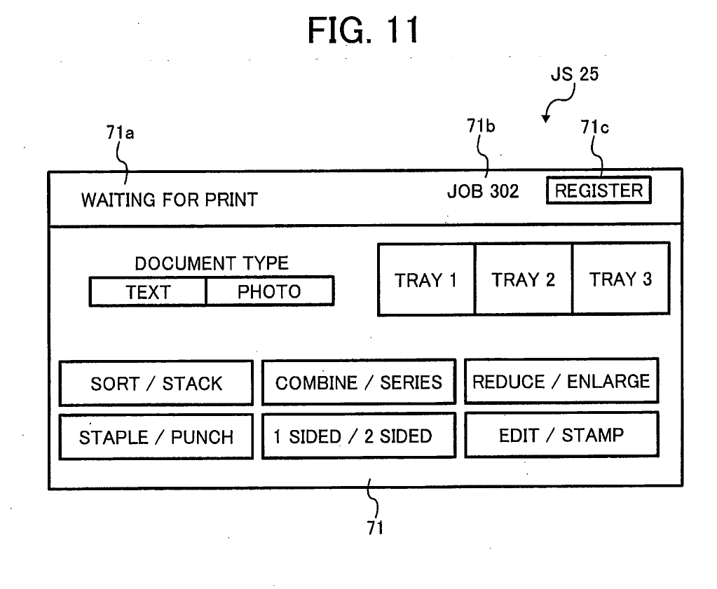

The operation of FIG. 9 may be performed in various other ways. For example, Step S109 may additionally cause the LCD 71 to change the screen from the second job screen JS22 of FIG. BB to a second job screen JS25 of FIG. 11. The indicator section 71a of the second job screen JS25 of FIG. 11 displays the phrase “WAITING FOR PRINT” to indicate that the second job status information is set to “WAITING”. The second job screen JS25 of FIG. 11 is then automatically switched back to the first job screen J314 of FIG. 7 in Step S113.

Further, the image forming apparatus 1 may have a structure different from the structure shown in FIG. 3. For example, the main controller 10 of FIG. 3 may be additionally provided with a timer.

The timer obtains a counted timer value indicating a time period counted from the time when the second job status information has been changed from “SCANNING” to “WAITING”, and outputs the counted timer value to the CPU 11. Based on the counted timer value, the CPU 11 may control the timing a which the screen of the LCD 71 is switched from the second job screen back to the first job screen. For example, when the counted timer value is less than a reference timer value, the CPU 11 continues to display the second jot screen, such as the second job screen JS25 of FIG. 11. When the counted timer value is equal to or greater than the reference timer value, the CPU 11 switches from the second job screen back to the first job screen.

The reference timer value may be previously set at the time of manufacturing the image forming apparatus 1. Alternatively, the reference timer value may be set by the user. For example, when the “SETTINGS” key 72f (FIG. 6) is pressed, the LCD 71 displays a settings screen, such as the settings screen shown in FIG. 12. The user may set the reference timer value by inputting an arbitrary number in the “JOB SWITCH TIMER” section 71g, using the ten key 72a

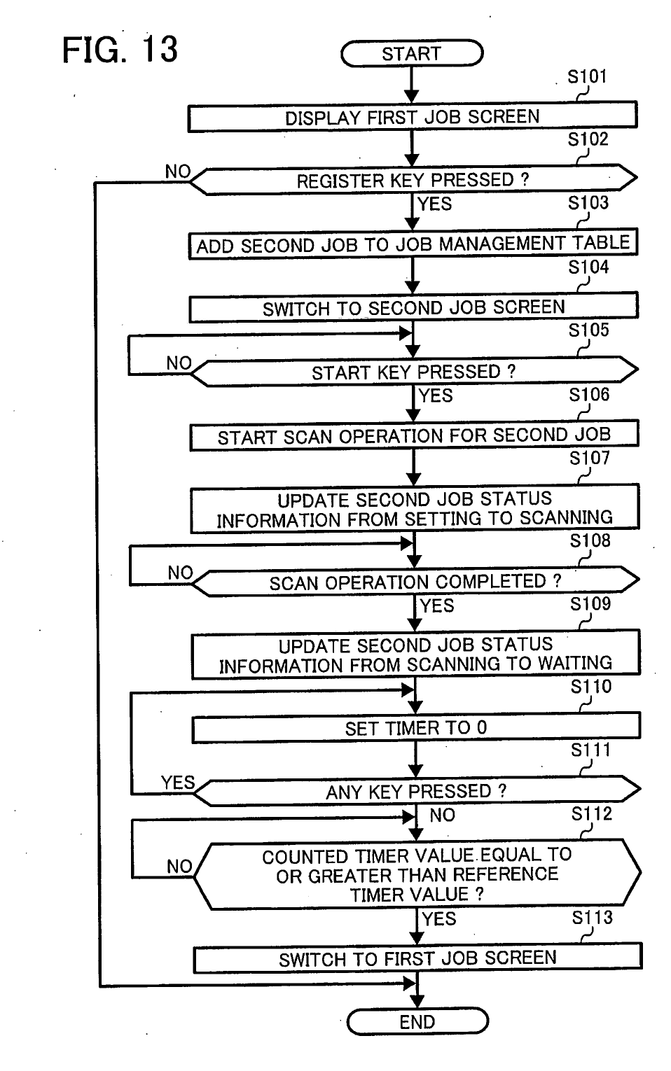

Referring now to FIG. 13, the operation of controlling the screen of the LCD 71 is explained according to an example embodiment of the present invention. The operation shown in FIG. 13 is performed by the CPU 11 provided with the timer, when the first job is being performed. Further, the operation of FIG. 13 is substantially similar to the operation of FIG. 9, except for the addition of Steps S110, S111, and S112, which will be described below.

Step S110 sets the counted timer value of the timer to 0. In this example, the LCD 71 displays the second job screen JS25 of FIG. 11 to inform the user that the second status job information is set to “WAITING”.

Step S111 determines whether any key has been pressed by the user. If any key has been pressed (“YES” in Step S111), the operation returns to Step S110 after performing the operation according to the pressed key. If no key has been pressed (“NO” in Step S111), the operation proceeds to Step S112.

Step S112 determines whether the counted timer value is equal to or greater than the reference timer value. If the counted timer value is equal to or greater than the reference timer value (“YES” in Step S112), the operation proceeds to Step S113. Otherwise (“NO” in Step S112), the operation returns to Step S12.

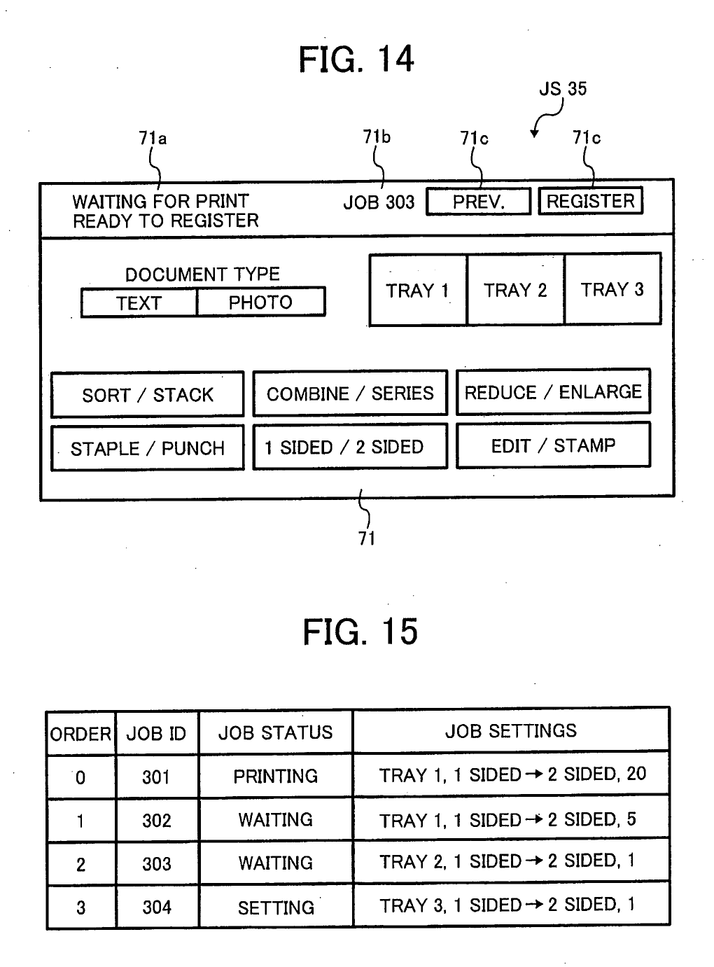

In Step S111, the user may input an additional command to cause the image processing apparatus 1 to perform a wide variety of operations, for example, as described below referring to any one of FIGS. 14 to 19.

In one example, the user may continue to register one or more jobs by pressing the “REGISTER” key 71c of the second job screen JS25 of FIG. 11. For example, assuming that the user wants to register a third job, which is to copy a third original document of 1 page, and a fourth job, which is to copy a fourth original document of 1 page, the user first presses the “REGISTER” key 71c of the second job screen JS25 of FIG. 11. When the “REGISTER” key 71c is pressed, the LCD 71 displays a third job screen including information regarding the third job. Using the third job screen, the user may set third job settings information of the third job, and starts the scanning operation on the third job. Upon completion of the scanning operation, the LCD 71 may display a third job screen JS35 shown in FIG. 14. The indicator section 71a of the third job screen JS35 displays the phrase “WAITING FOR PRINT. READY TO REGISTER.” to inform the user that another job can be registered. By pressing the “REGISTER” key 71c, the user registers the fourth job. Accordingly, as illustrated in FIG. 15, information regarding the third job and information regarding the fourth job are added to the job management table.

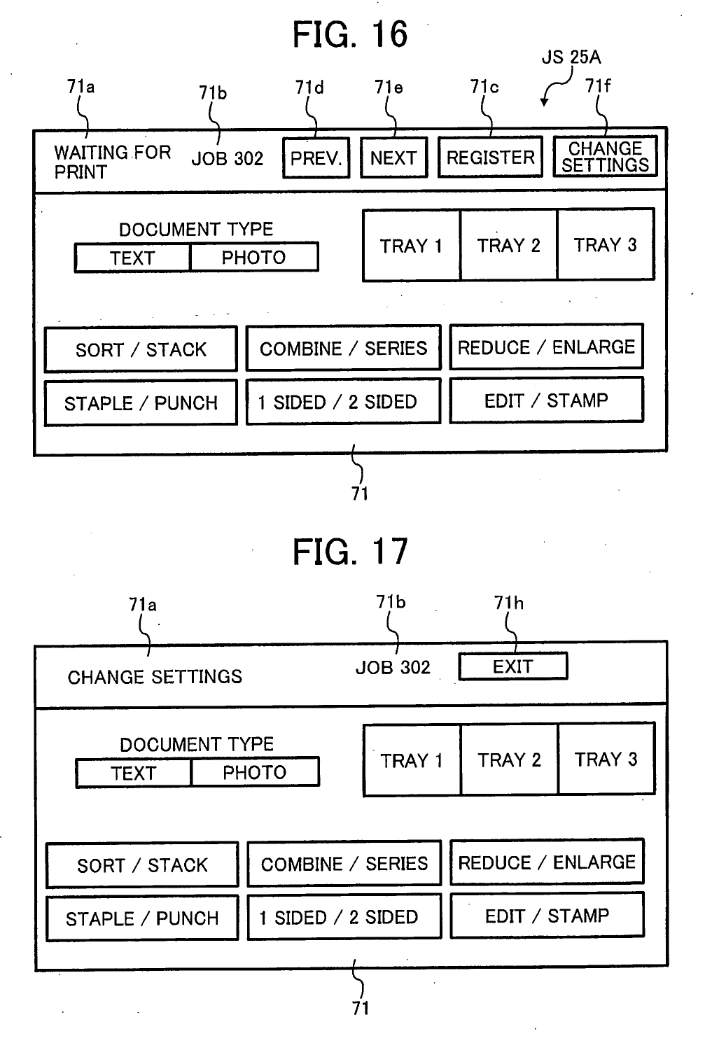

In another example, the user may change the screen of the LCD 71 to show any one of the registered jobs listed in the job management table. For example, the LCD 71 may display a “PREV” key, such as the “PREV” key 71c included in the third job screen JS35 of FIG. 14. By pressing the “PREV” key 71c, the user can switch from the third job screen JS35 to any one of the first and second job screens. In this manner, the user can obtain information regarding any one of the previously registered jobs, without waiting for the first job to be completed. Similarly, the LCD 71 may display a “NEXT” key, such as the “NEXT” key 71e included in a second job screen JS25A of FIG. 16. By pressing the “NEXT” key 71e, the user can switch from the second job screen JS25A to any one of the third and fourth job screens.

In another example, the user may change the settings of the previously registered jobs. For example, the LCD 71 may display a “CHANGE SETTINGS” key, such as the “CHANGE SETTINGS” key 71f included in the second job screen JS25A shown in FIG. 16. When the “CHANGE SETTINGS” key 71f is pressed, the LCD 71 displays a second job screen shown in FIG. 17. Using the second job screen of FIG. 17, the user may change the second job settings information, i.e., the current settings of the second job. To go back to the second job screen JS25A, the user may press the “EXIT” key 71h shown in FIG. 17.

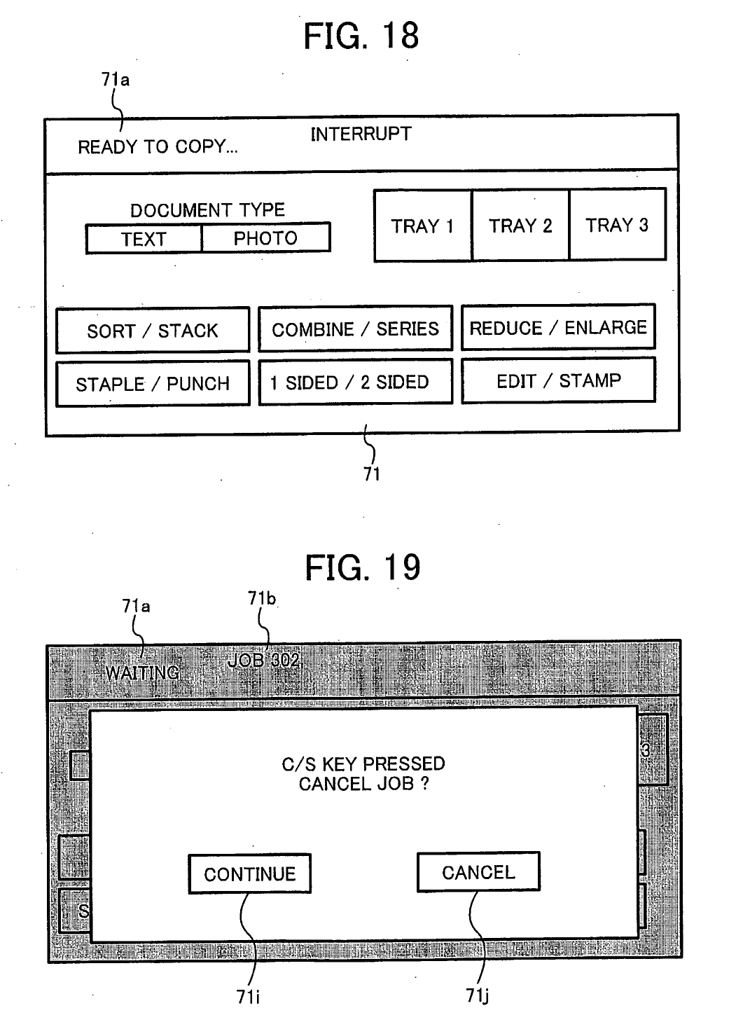

In another example, the user may interrupt the first job, which is currently performed. For example, when the user presses the “INTERRUPT” key 72e (FIG. 6), the LCD 71 displays an interrupt screen shown in FIG. 18 to allow the user to perform a new job while suspending the first job. At this time, the first job status information may be 20 changed from “PRINTING” to “WAITING”. In this manner, the user can use the printer 50 to perform the printing operation on the new job.

In another example, the user may cancel any one of the previously registered jobs. For example, when the C/S key 72b (FIG. 6) is pressed, the LCD 71 displays a cancel screen shown in FIG. 19. As shown in FIG. 19, the cancel screen asks the user to keep the job in the job management table, or delete the job from the job management table. When the user determines to delete the job, such as by pressing a “CANCEL” key 71j of FIG. 19, the CPU 11 deletes the corresponding job from the job management table. Accordingly, the deleted job is not performed.

Numerous additional modifications and variations are possible in light of the above teachings. It is therefore to be understood that within the scope of the appended claims, the disclosure of this patent specification may be practiced in ways other than those specifically described herein.

For example, elements and/or features of different illustrative embodiments may be combined with each other and/or substituted for each other within the scope of this disclosure and appended claims.

Further, as described above, any one of the above-described and other methods of the present invention may be embodied in the form of a computer program stored in any kind of storage medium. Examples of storage mediums include, but are not limited to, flexible disk, hard disk, optical discs, magneto-optical discs, magnetic tapes, involatile memory cards, ROM, etc. Furthermore, information regarding a plurality of jobs, such as job status information or job settings information, may be stored in any other form, or it may be provided in other various ways.

Alternatively, any one of the above-described and other methods of the present invention may be implemented by ASIC, prepared by interconnecting an appropriate network of conventional component circuits or by a combination thereof with one or more conventional general purpose microprocessors and/or signal processors programmed accordingly.

Furthermore, the image forming apparatus 1 may be implemented in various other ways. For example, a CPU may be provided in any one of the scanner 40 and the printer 50 shown in FIG. 3.

Furthermore, the screen displayed by the LCD 71 is not limited to the above-described examples. For example, the indicator section 71a of the LCD 71 may display any other kind of message or information.

1. An image forming apparatus, comprising:
reading means for reading an original document into image data;
storing means for storing the image data read by the reading means;
printing means for printing the image data stored by the storing means as a printed document;
inputting means for subsequently inputting a first job execution command, which causes the reading means, the storing means, and the printing means to cause the operations of reading, storing, and printing in a first job; and a second job execution command, which causes the reading means, the storing means, and the printing means to cause the operations of reading, storing, and printing in a second job;
registering means for registering the first job in response to the first job execution command and the second job in response to the second job execution command;
managing means for managing first job status information of the first job and second job status information of the second job according to at least one of the operations performed by the inputting means, the reading means, the storing means, and the printing means;
deleting means for deleting the first job according to the first job status information and the second job according to the second job status information;
displaying means for displaying one of a first screen including the first job status information and a second screen including the second job status information; and
switching means for causing the displaying means to automatically switch between the first screen and the second screen at a timing determined by relative relationship between the first job status information and the second job status information.

2. The apparatus of claim 1, wherein the first screen is switched to the second screen when the first job status information indicates that the operation of printing is performed by the printing means while the second job status information indicates that the operation of inputting is performed by the inputting means, and wherein the second screen is switched back to the first screen when or after the first job status information indicates that the operation of printing is performed by the printing means while the second job status information indicates that the operations of inputting, reading, and storing are respectively completed by the inputting means, reading means, and storing means.

3. The apparatus of claim 2, wherein the switching means comprises:
counting means for obtaining a counted timer value, wherein the second screen is switched back to the first screen when the counted timer value is equal to or greater than a reference timer value.

4. The apparatus of claim 3, wherein the reference timer value is input by the inputting means.

5. The apparatus of claim 3, wherein the counted timer value is a time period counted from a timing when the second job status information indicates that the operations of inputting, reading, and storing are respectively completed.

6. The apparatus of claim 3, wherein the inputting means is configured to further input an additional command when the counted timer value is less than the reference timer value.

7. The apparatus of claim 6, wherein the counted timer value is a time period counted from a timing when an operation performed in response to the additional command is completed.

8. An image forming apparatus capable of performing a plurality of jobs, comprising:
a scanner configured to perform a scanning operation on at least one of the plurality of jobs at a time;
a storage device configured to store a job management table storing various information regarding the plurality of jobs, wherein the plurality of jobs includes a first job being currently performed and a second job to be performed after completion of the first job;
a display configured to display at least one of a first screen showing information regarding the first job and a second screen showing information regarding the second job; and
a controller configured to cause the display to switch from the second screen to the first screen at a timing occurred when or after the scanning operation on the second job is completed by the scanner.

9. A method for controlling a display of an image forming apparatus currently performing a first job, the method comprising the steps of:
displaying a first screen showing information regarding the first job on the display;
first determining whether a command for registering a second job is input;
switching the display from the first screen to a second screen including information regarding the second job when the first determining step determines that the command is input;
second determining whether a scanning operation on the second job is completed; and
switching the display from the second screen back to the first screen when the second determining step determines that the scanning operation is completed.

10. The method of claim 9, further comprising the steps of:
obtaining a counted timer value counted from a timing when the scanning operation is completed on the second job; and
comparing the counted timer value with a reference timer value to generate a comparison result.

11. The method of claim 10, wherein the display is switched from the second screen back to the first screen when the comparison result indicates that the counted timer value is equal to or greater than the reference timer value.

12. The method of claim 10, wherein the reference timer value is set by a user.

13. The method of claim 10, wherein the comparison result indicates that the counted timer value is less than the reference timer value, the method further comprising the steps of:
determining whether an additional command is input;
initializing the counted timer value to obtain an updated counted timer value counted from a timing when an operation in response to the additional command is completed; and
comparing the updated counted timer value with the reference timer value to generate an updated comparison result.

14. The method of claim 13, wherein the display is switched from the second screen back to the first screen when the updated comparison result indicates that the updated counted timer value is equal to or grater than the reference timer value.

15. A computer program, adapted to, when executed on a processor coupled to a display, cause the processor to carry out a method of controlling the display, the method comprising:
displaying a first screen on the display, which corresponds to a first job being currently performed by the processor;
switching the display, from the first screen, to a second screen corresponding to a second job in response to a command for registering the second job; and
switching the display from the second screen back to the first screen at a timing when or after an reading operation is completed on the second job.

16. A computer readable medium storing computer instructions for performing a method of controlling a display of an image forming apparatus, the method comprising:
displaying a first screen on the display, which corresponds to a first job being currently performed by the image forming apparatus;
switching the display, from the first screen, to a second screen corresponding to a second job in response to a command for registering the second job; and
switching the display from the second screen back to the first screen at a timing when or after the image forming apparatus completes an reading operation or the second job.
